(19) United States
(12) Patent Application Publication
(10) Pub. No.: US 2002/0135189 A1
(43) Pub. Date: Sep. 26, 2002

(54) Integrated lifting apparatus

(76) Inventor: Victor Joseph Segura, New Iberia, LA (US)

Correspondence Address: Ted M. Anthony, Perret Doise, Post Office Drawer 3408, Lafayette, LA, 70502, US

(21) Appl. No.: 09/814,553

(22) Filed: Mar. 22, 2001

(51) Int. Cl. B66C 1/00

(52) U.S. Cl. 294/1.1; 294/67.4

(57) ABSTRACT

An integrated lifting apparatus for attaching a sling or other lifting means to a load having an upright and substantially hollow post. A bore is provided near the upper extent of such hollow post, said bore extending horizontally through said hollow post. A threaded bolt having an enlarged head on one end, preferably constructed of high strength and/or shear resistant material, is disposed through said bore. A lock nut having an outer diameter greater than the diameter of said bore is threaded onto the end of said bolt. If desired, a cotter pin can also be used to secure such lock nut on said bolt.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention relates to a lifting apparatus which can be used in connection with a crane or hoist for the loading or unloading of cargo. More specifically, the present invention relates to a lifting apparatus which improves the strength characteristics of pallets, baskets and other structures used for containing or supporting loads being lifted, while eliminating the need for welded pad-eyes, loops or similar structures.

2. Description of the Related Art

Numerous arrangements have been devised for the purpose of lifting large production skids or similar equipment so that they may be transported from one location, such as on board a boat, to another location, such as an offshore platform using a crane, hoist or other lifting means. In the course of such transport activities, consideration must be given to the maintenance of control during the lifting process, as well as to other primary considerations such as facility in making connections and disconnections, and the protection or preservation of the equipment being transported. Perhaps more significantly, consideration must also be given to the minimizing of possible failure locations on the lift equipment.

In carrying out lift operations of this type, large or heavy loads are typically lifted using a set of slings connected to the line of a crane or hoist. Although it is often possible to connect a crane or hoist line directly to a load to be lifted, slings generally provide an intermediate means to quickly and efficiently connect such line to the load. Further, because many slings utilize two or more separate lines connected to a central link or loop, slings generally allow for more even weight distribution during the lifting process. When such slings are used, the end of the various sling lines are attached to the particular load to be lifted, while the central link of the slings is connected to the line of a crane or hoist.

This method of using slings to lift and/or transport equipment, cargo or other loads is very common in offshore or marine operations, as well as numerous other applications such as the loading and unloading of ships and other vessels at loading docks. It should be noted that the offshore oil and gas industry, although representative of the issues faced in the lifting and transportation of heavy loads, is but one example of an industry facing such issues.

Generally, when slings are used for lifting large or heavy loads, the various lines of such slings are attached to pad-eyes which are welded or otherwise affixed to the load in question. For example, large baskets used to transport cargo to or from an offshore platform may have one or more pad-eyes welded to the exterior of such baskets. In many instances, shackles or other joining means can be used to connect the various lines of the slings to such pad-eyes. Welded pad-eyes can exhibit satisfactory strength characteristics. However, if such welds are required over time to support heavy loads on multiple lifts, said welds can become subject to fatigue over time. Obviously, when loads are being lifted from great heights, such as from a boat to an offshore oil and gas platform, a broken weld on a pad-eye could have disastrous consequences. A large load dropped from a high elevation could severely damage property, or worse, injure or kill personnel in the area.

In the offshore oil and gas industry, as well as numerous other industries wherein heavy loads are routinely lifted, safety is of paramount concern. In order to reduce or eliminate failure of welded pad-eyes, many operators of offshore facilities have instituted scheduled inspection of welded pad-eyes. In some cases, operators utilize x-ray inspection to detect cracks or other signs of weakness in welds on pad-eyes. Of course, if a particular weld fails inspection, the equipment in question is repaired or entirely removed from service. In some cases, operators may replace pad-eyes, or entirely remove the equipment in question from service, based on the number of lifts that have been performed using the pad-eyes in question.

Hence, the invention described herein provides an integrated lifting apparatus having strength characteristics which meet or exceed those of welded pad-eyes, while eliminating the need for welded parts. By eliminating the need for welded parts, users can avoid the requirement of expensive inspection programs, as well as the costs associated with taking equipment out of service on a temporary or permanent basis. Further, the invention described herein provides an integrated lifting apparatus which can be quickly and easily connected to, or disconnected from, a set of slings or other lines used in the lifting process.

### SUMMARY OF THE INVENTION

The present invention discloses an integrated lifting apparatus which eliminates the problems associated with welded pad-eyes. The present invention can be integrally attached to the item to be lifted, such as on a basket or the like. Alternatively, the present invention can be integrally attached to a skid, pallet or other platform upon which otherwise free-standing equipment or cargo can be loaded.

In the preferred embodiment, each integrated lifting apparatus of the present invention comprises a hollow post. A bore is provided near the upper extent of such hollow post, said bore extending through said hollow post. A threaded pin or bolt having an enlarged head on one end, preferably constructed of high strength and/or shear resistant material, is disposed through said bore. In the preferred embodiment, said bolt is at least partially threaded. A lock nut having an outer diameter greater than the diameter of said bore is threaded onto the end of said bolt. If desired, a cotter pin can also be used to secure such lock nut on said bolt.

The individual lines of a set of slips (or the line of a crane or hoist itself) can be easily attached to a load to be lifted using the lifting apparatus of the present invention. The procedure for attaching such slings, or other lines is as follows. If a cotter pin is used, it is first removed. Thereafter, the lock nut is unscrewed from the high strength bolt, and the bolt is removed from the bore in the hollow post. A sling loop (or shackle) is then placed between the walls of the hollow post, and the high strength bolt is re-inserted through said bore, as well as said sling loop or shackle. The lock nut is then threaded back on to the high strength bolt. If desired, the cotter pin is then installed to help ensure that the lock nut remains in place. When multiple-line slings are used, each line of said slings can be attached to the load in question using two or more of the lifting apparatuses of the present invention. As is readily apparent, the process is simply reversed in order to remove such sling from the lifting apparatus of the present invention.

In certain applications, it may be desirable to allow a set of slings, attached to a piece of equipment or other load using the integrated lifting apparatus of the present invention in the manner set forth above, to remain so attached. By doing so, a user needs only to attach the line from a crane or hoist directly on to the central link of such slips in order to lift the load in question. This greatly reduces the amount of time and effort required to hook a crane or hoist line to a load to be lifted, as well as the time and effort required to unhook same. Further, when a particular set of slings has been used for a predetermined number of lifts, such slings can be quickly and easily removed and replaced. The removed slings can be discarded or refurbished, as desired.

### BRIEF DESCRIPTION OF THE DRAWINGS

FIG. 1 is a diagrammatic view depicting equipment being loaded from an offshore platform to a boat using a crane.

FIG. 2 is a side view of a basket equipped with the lifting apparatus of the present invention.

FIG. 3 is a top view of the integrated lifting apparatus of the present invention.

FIG. 4 is a side view of the integrated lifting apparatus of the present invention without a high strength bolt in place.

FIG. 5 is a side view of the integrated lifting apparatus of the present invention, shown with one line of a sling attached thereto.

FIG. 6 is a side cut away view of the integrated lifting apparatus of the present invention.

### DESCRIPTION OF THE PREFERRED EMBODIMENT(S)

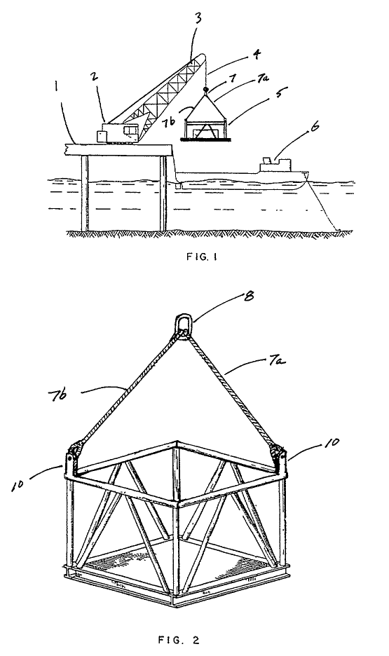

Referring to the drawings, FIG. 1 depicts a diagrammatic view of equipment being loaded from an offshore platform to a waiting boat using a crane. Platform 1 provides a foundation for crane 2, having boom 3 and line 4. Basket 5 is depicted as being lowered onto waiting boat 6 using crane 2. Slings 7 are used to connect line 4 of crane 2 to basket 5. Slings 7 utilize multiple lines 7a and 7b, to evenly distribute the weight of basket 5, and provide stability during the lift and transfer of basket 5. It is well known in the prior art to utilize pad-eyes, welded or otherwise attached to a load such as basket 5, to provide connection means for attaching lines 7a and 7b of sling 7 to basket 5. The integrated lifting means of the present invention eliminates the need for such pad-eyes, and the problems associated with same.

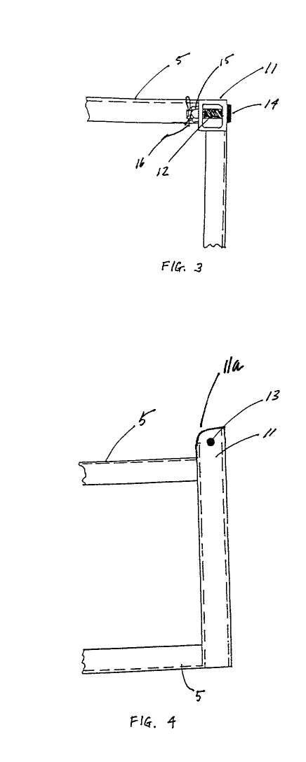

FIG. 2 depicts basket 5 equipped with the integrated lifting apparatus 10 of the present invention; to improve stability of the load during the lift, basket 5 is equipped with two such lifting apparatuses at opposing corners of basket 5. Of course, many different numbers and configurations of such lifting apparatuses can be employed relative to basket 5, or other similar loads. The lower ends of lines 7a and 7b of slings 7 are each attached to an integrated lifting apparatus 10, while the upper ends of lines 7a and 7b are connected to central loop 8 of slings 7. When using a crane or hoist to lift basket 5, the line of such crane or hoist (such as line 4 of FIG. 1, for example) can be hooked or otherwise attached to central loop 8 of slings 7.

FIG. 3 depicts a top view of integrated lifting apparatus 10 of the present invention. In the preferred embodiment, hollow vertical post 11 forms a corner post of basket 5. Bolt 12 is inserted within a bore 13 (not shown in this view) extending horizontally through hollow vertical post 11. Bolt 12 has enlarged head 14, having a diameter larger than the bore 13 through said hollow vertical post 11. The end of bolt 12, which is opposite of head 14, has threads. Lock nut 15 is threaded on to bolt 12. In the preferred embodiment, cotter pin 16 is inserted through a bore in bolt 12 in order to ensure that lock nut 15 remains in place on bolt 12.

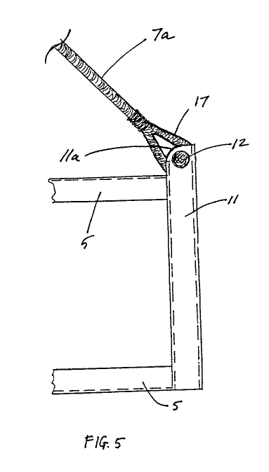

FIG. 4 depicts a side view of integrated lifting apparatus 10 of the present invention. In the preferred embodiment, hollow post 11 forms an integral corner member of basket 5. However, it should be noted that hollow post 11 can be attached to, or incorporated in, the load to be lifted in any number of different ways. Bore 13 extends horizontally through hollow post 11. In the preferred embodiment, upper surface 11a of hollow post 11 is rounded to provide greater access to bolt 12.

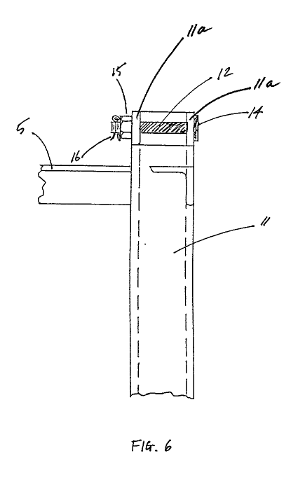

FIG. 5 depicts a side view of the integrated lifting apparatus of the present invention with one line of a multiple-line sling attached thereto. Hollow vertical post 11 forms a corner post of basket 5. Bolt 12 is inserted within bore 13 (not shown in this view), and passes through loop 17 of sling line 7a. Although bolt 12 is shown passing through loop 17 of sling line 7a, it should be recognized shackles and other similar means could be used to attach said sling line 7a to the integrated lifting apparatus of the present invention. In the preferred embodiment, upper edge 11a of hollow vertical post 11 is rounded to provide a concave shape, thereby improving the strength characteristics of hollow vertical post 11 during lifting operations.

FIG. 6 depicts a side cut away view of the integrated lifting apparatus of the present invention. Hollow vertical post 11 forms a corner post of basket 5. Bolt 12 is inserted within a bore 13 extending horizontally through hollow vertical post 11. Bolt 12 has enlarged head 14, having a diameter larger than the bore through said hollow vertical post 11. The end of bolt 12, which is opposite of head 14, has threads. Lock nut 15 is threaded on to bolt 12. Cotter pin 16 is inserted through a bore in bolt 12 in order to ensure that lock nut 15 remains in place on bolt 12. Upper surface 11a of hollow vertical post 11 is rounded or otherwise tapered, thereby resulting in the removal of a portion of said hollow vertical post 11 in the general area of bolt 12. Such rounding or tapering of upper surface 11a generally permits greater freedom of movement for a shackle or sling which may be attached to bolt 12.

In the preferred embodiment, a line of a sling can be easily attached to the lifting apparatus of the present invention. Referring to FIG. 6, cotter pin 16 is first removed. Thereafter, lock nut 15 is unscrewed from high strength bolt 12, and said bolt is removed from bore 13 in hollow vertical post 11. A sling loop (or shackle) is then placed between the walls of hollow vertical post 11 so that the opening in said loop is aligned with bore 13. High strength bolt 12 is re-inserted through said bore, as well as the opening of said sling loop. Lock nut 15 is then re-threaded back on to the end of high strength bolt 12. If desired, cotter pin 16 is then installed to help ensure that the lock nut remains in place. As is readily apparent, the process is simply reversed in order to remove such sling from the lifting apparatus of the present invention.

Although preferred embodiments of the subject invention have been described herein, it should be understood that various changes, adaptations and modifications may be made therein without departing from the spirit of the invention and the scope of the appended claims.

What is claimed is:

1. A lifting apparatus comprising:
a. a substantially hollow vertical member;
b. a roughly horizontal bore extending through said vertical member;
c. a cylindrical member disposed through said roughly horizontal bore; and
d. means for securing said cylindrical member within said roughly horizontal bore.

2. The lifting apparatus of claim 1, wherein said cylindrical member is a bolt having threads.

3. The lifting apparatus of claim 2, wherein said means for securing said bolt in said roughly horizontal bore comprises a nut screwed on the threads of said bolt.

4. The lifting apparatus of claim 3, further comprising:
a. a channel extending through said bolt, wherein said channel is oriented perpendicular to the longitudinal axis of said bolt; and
b. a cotter pin disposed within said channel.

5. A lifting apparatus comprising:
a. a vertical member having a first side and a second side, wherein said first and second sides are roughly parallel to one another, thereby defining a gap between said first and second sides;
b. a first roughly horizontal bore extending through said first side;
c. a second roughly horizontal bore extending through said second side, wherein said first and second roughly horizontal bores are aligned with one another;
d. a cylindrical member disposed through said first and second roughly horizontal bores; and
e. means for securing said cylindrical member within said roughly horizontal bores.

6. The lifting apparatus of claim 5, wherein said cylindrical member is a bolt having threads.

7. The lifting apparatus of claim 6, wherein said means for securing said bolt within said roughly horizontal bores comprises a nut screwed on the threads of said bolt.

8. The lifting apparatus of claim 5 wherein the upper surfaces of said first and second sides of said upright member are rounded.

9. The lifting apparatus of claim 7 further comprising
a. a hole extending through said bolt; and
b. a cotter pin disposed within said hole.
